(19) United States
(12) Patent Application Publication
(10) Pub. No.: US 2022/0386430 A1
(43) Pub. Date: Dec. 1, 2022

(54) HEAT TREATMENT DEVICE

(71) Applicants: HUAN-JUN GUO, Kaohsiung City (TW); PO-YEN CHIU, New Taipei City (TW)

(72) Inventors: HUAN-JUN GUO, Kaohsiung City (TW); PO-YEN CHIU, New Taipei City (TW)

(21) Appl. No.: 17/727,854

(22) Filed: Apr. 25, 2022

(30) Foreign Application Priority Data
May 26, 2021 (TW) 110118996

(51) Int. Cl. H05B 6/78; A23N 12/08

(52) U.S. Cl. CPC H05B 6/782; A23N 12/08

(57) ABSTRACT

A heat treatment device suitable for performing heat treatment on a material is provided. The heat treatment device includes a cavity, a microwave generator, and a stirring element. The material is arranged in the cavity. The microwave generator is arranged beside the cavity and is suitable for providing a microwave into the cavity. The stirring element is arranged beside the cavity and is suitable for stirring the material.

### FIELD OF THE INVENTION

The present invention relates to a heat treatment device, and more particularly to a heat treatment device using microwaves.

### BACKGROUND OF THE INVENTION

Coffee is a drink made of roasted coffee beans and is one of the most popular drinks in the world. According to the statistics of Business Insider, the global output value of coffee is up to hundred billion US dollars. The quality and price of coffee depend on its unique aroma and taste; however, not only does the type of the coffee beans affect the aroma and taste of coffee, the roasting process of the coffee beans also seriously affects the aroma and taste of coffee.

Heat sources of heating devices for roasting the coffee beans can be divided into non-penetrating heat sources and penetrating heat sources. In the case when the heating device uses the non-penetrating heat source, the non-penetrating heat source indirectly heats the coffee beans by heating a cavity or air, so that the inside and outside of the coffee beans tend to be heated to different degrees, which will affect their taste and quality. Moreover, because the non-penetrating heat source is generally burning gas or charcoal fire, the form factor of its heating device is difficult to miniaturize, which leads to the disadvantages of the heating device being too large and highly dangerous.

The heat source of a commercially-available microwave oven is a kind of penetrating heat source, which has both high efficiency and safety. The principle of microwave heating is to send a microwave into a heating chamber, in which the microwave is constantly reflected and resonated to form a standing wave. Under the action of the standing wave, the water molecules or polar molecules in the coffee beans placed in the heating chamber are violently vibrated and rubbed against each other to generate heat. However, the energy distribution of the standing wave structure is not uniform. Specifically, the energy of a node position of the standing wave is almost zero, while the energy of an antinode position of the standing wave is the highest, and such a difference causes the uneven heating area of the coffee beans. Although the microwave oven can achieve a uniform heating effect by rotating the object, this manner is difficult to apply to a large area of coffee beans.

### SUMMARY OF THE INVENTION

The present invention provides a heat treatment device, which can uniformly heat a material.

A heat treatment device provided by an embodiment of the present invention is suitable for performing heat treatment on a material. The heat treatment device includes a cavity, a microwave generator, and a stirring element. The material is arranged in the cavity. The microwave generator is arranged beside the cavity and suitable for providing a microwave into the cavity. The stirring element is arranged beside the cavity and suitable for stirring the material.

In one embodiment of the invention, the cavity includes a first chamber and a second chamber. The material is arranged in the second chamber. The microwave is reflected within the first chamber and the second chamber.

In one embodiment of the invention, the stirring element includes a motor and a rotating shaft. The motor is connected to the rotating shaft. The second chamber is sleeve-connected and fixed to the rotating shaft. The rotating shaft is suitable for driving the second chamber to rotate.

In one embodiment of the invention, the second chamber is cylindrical. The stirring element includes a motor and a gear. The motor is connected to the gear. The gear abuts against the second chamber and is suitable for driving the second chamber to rotate.

In one embodiment of the invention, the second chamber is arranged in the first chamber.

In one embodiment of the invention, the second chamber is arranged beside the first chamber and connected to the first chamber.

In one embodiment of the invention, one side of the second chamber has a baffle plate, and the microwave enters the second chamber through the baffle plate.

In one embodiment of the invention, the aforementioned heat treatment device further includes a hot air device. An air outlet is arranged on one side of the second chamber. The hot air device is suitable for generating hot air into the second chamber and then the hot air is discharged from the air outlet.

In one embodiment of the invention, the aforementioned heat treatment device further includes an air exhausting device connected to an air outlet arranged on one side of the second chamber.

In one embodiment of the invention, the stirring element includes a fan suitable for pushing air into the cavity to aerodynamically stir the material inside the cavity.

In the heat treatment device of the embodiments of the present invention, the microwave generator provides the microwave into the cavity to perform heat treatment on the material in the cavity, and then the material is stirred by the stirring element, so that the material can be constantly turned over in the cavity. Thus, the microwave can be evenly transmitted to every part of the material, thereby achieving the effect of high efficiency and stable, uniform heating.

### BRIEF DESCRIPTION OF THE DRAWINGS

The present invention will become more readily apparent to those ordinarily skilled in the art after reviewing the following detailed description and accompanying drawings, in which:

FIG. 1 is a schematic perspective view of a heat treatment device according to an embodiment of the present invention;

FIG. 2 is a schematic cross-sectional view of a heat treatment device according to an embodiment of the present invention;

FIG. 3 is a schematic view of a baffle plate according to an embodiment of the present invention;

FIG. 4 is a schematic cross-sectional view of a heat treatment device according to another embodiment of the present invention;

FIG. 5 is a schematic perspective view of a heat treatment device according to another embodiment of the present invention;

FIG. 6 is a schematic cross-sectional view of a heat treatment device according to another embodiment of the present invention; and

FIG. 7 is a schematic cross-sectional view of a heat treatment device according to another embodiment of the present invention.

### DETAILED DESCRIPTION OF PREFERRED EMBODIMENTS

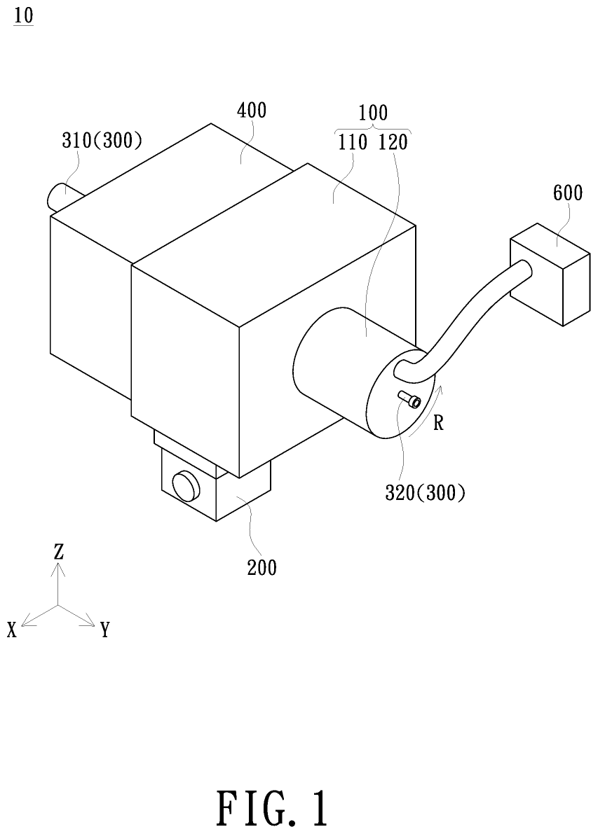

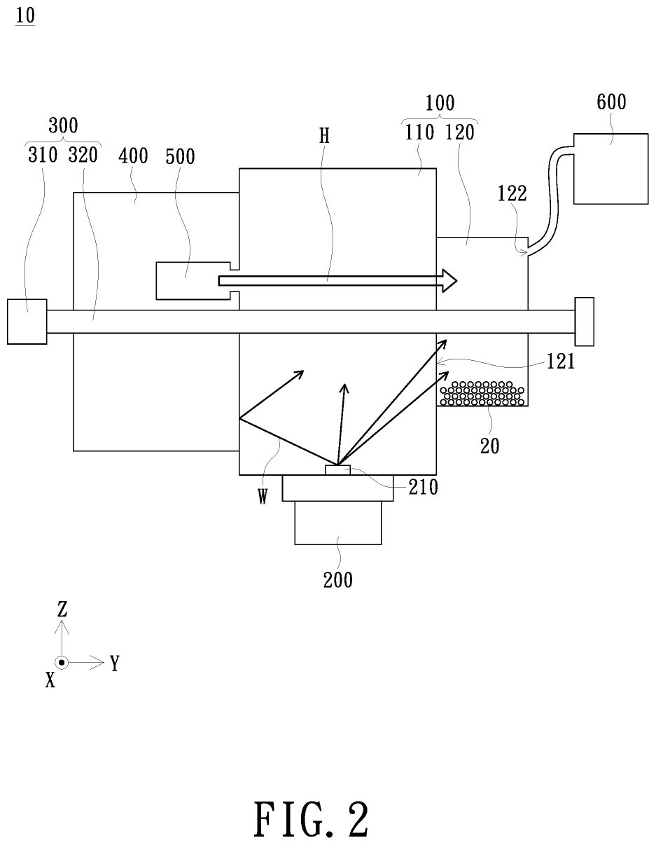

FIG. 1 is a schematic perspective view of a heat treatment device according to an embodiment of the present invention. FIG. 2 is a schematic cross-sectional view of a heat treatment device according to an embodiment of the present invention. Please refer to FIGS. 1 and 2. The heat treatment device 10 of this embodiment is suitable for performing heat treatment on a material 20. The heat treatment device 10 includes a cavity 100, a microwave generator 200 and a stirring element 300. The material 20 is arranged in the cavity 100. The microwave generator 200 is arranged beside the cavity 100 and is suitable for providing a microwave W into the cavity 100. The stirring element 300 is arranged beside the cavity 100 and is suitable for stirring the material 20.

In this embodiment, the cavity 100 includes, for example, a first chamber 110 and a second chamber 120, but the invention is not limited thereto. In another embodiment, the space inside the cavity 100 may not be partitioned. The first chamber 110 and the second chamber 120 of the cavity 100 are partitioned from each other, for example, and the second chamber 120 is arranged beside the first chamber 110 and is connected to the first chamber 110. In this embodiment, the microwave generator 200 is connected to the first chamber 110, for example. The material 20 is arranged in the second chamber 120. After exiting the microwave generator 200, the microwave W will first enter the first chamber 110, and then is reflected in the first chamber 110 and then transmitted to the second chamber 120.

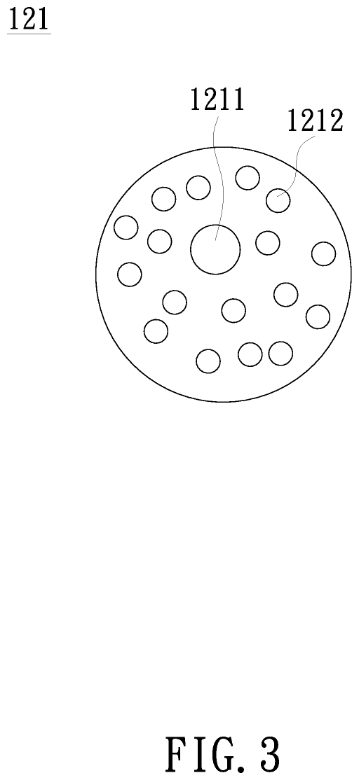

Specifically, the side of the second chamber 120 connected to the first chamber 110 has, for example, a baffle plate 121, and the shape of the baffle plate 121 corresponds to that of the second chamber 120, as shown in FIG. 3. For example, the shape of the baffle plate 121 is, for example, circular when the second chamber 120 of this embodiment is cylindrical. The material of the baffle plate 121 may include ceramics, quartz glass, Teflon, or other materials that can resist heat and allow the microwave W to pass therethrough. The function of the baffle plate 121 is to allow the microwave W to enter the second chamber 120 through the baffle plate 121, while preventing the material 20 from entering the first chamber 110. The baffle plate 121 may not be provided when the quantity of the material 20 is not large, so that the first chamber 110 and the second chamber 120 may be intercommunicated.

The material 20 in the second chamber 120 is subjected to uneven heat treatment when the microwave W enters the second chamber 120 through the baffle plate 121. Therefore, the heat treatment device 10 of this embodiment further needs the stirring element 300 to stir the material 20 for uniform heating. The stirring element 300 includes, for example, a motor 310 and a rotating shaft 320, and the motor 310 is connected to the rotating shaft 320. The baffle plate 121 has, for example, a through hole 1211. The rotating shaft 320 passes through the first chamber 110 and the through hole 1211, and the second chamber 120 is sleeve-connected and fixed to the rotating shaft 320. The rotating shaft 320 is suitable for driving the second chamber 120 to rotate along a rotation direction R. In FIG. 1, the direction of gravity (not shown) is parallel to a direction of Z-axis, for example, and the rotating shaft 320 is arranged along a direction of Y-axis, for example, but not limited thereto. Therefore, when the second chamber 120 rotates along the rotation direction R and under the condition that a rotation speed is properly controlled and not too fast, the material 20 in the second chamber 120 will fall under the effect of gravity when it rotates to the top due to a centrifugal force less than gravity, so as to achieve the effect of stirring. Thus, the material 20 can constantly change its position in the second chamber 120, thereby enabling the microwave W to be evenly transmitted to each part of the material 20. Specifically, the present invention does not particularly limit the setting direction of the rotating shaft 320, as long as it is not parallel to the direction of gravity and therefore the aforementioned effect can be achieved through the corresponding adjustment. On the contrary, when the setting direction of the rotating shaft 320 is parallel to the direction of gravity, a good stirring effect on the material 20 cannot be obtained when the centrifugal force is less than gravity. Even if the centrifugal force is greater than gravity, gravity will become resistance, which may cause more consumption of energy and cost to achieve the same stirring effect as above.

In this embodiment, the second chamber 120 is cylindrical, for example, but is not limited thereto. Because the second chamber 120 rotates along the rotation direction R, designing the second chamber 120 as being cylindrical is beneficial for rotation, and thus the material 20 arranged in the second chamber 120 can smoothly roll during the stirring process. The shape of the first chamber 110 is different from that of the second chamber 120, for example, but is not limited thereto. The shape of the first chamber 110 can be the same as that of the second chamber 120 according to different design requirements.

The microwave generator 200 includes an antenna 210, a magnetron (not shown), and a transformer (not shown), etc. Because the microwave generator 200 is a known device, no redundant detail is to be given herein. The antenna 210 protrudes from the microwave generator 200 and extends into the first chamber 110. The microwave W is emitted from the antenna 210. Because the microwave generator 200 is directly connected to the first chamber 110, the heat treatment device 10 of this embodiment does not need to be provided with an additional waveguide which can save cost and improve safety by removing the risk of the waveguide breaking In FIGS. 1 and 2, the number of the microwave generator 200 is one as an example, but the present invention does not particularly limit the number of the microwave generators 200, there may also be two or more microwave generators 200.

In the heat treatment device 10 of this embodiment, the microwave generator 200 provides the microwave W into the cavity 100 to perform heat treatment on the material 20 in the cavity 100, and then the material 20 is stirred by the stirring element 300, so that the material 20 can be continuously turned over in the cavity 100 and thus the microwave W can be evenly transmitted to each part of the material 20, thereby achieving the effect of high efficiency and stable, uniform heating.

In this embodiment, the material 20 is, for example, coffee beans, and the heat treatment device 10 is used to perform a roasting process on the coffee beans, but it is not limited thereto. The heat treatment device 10 can also be used for baking or drying other articles, such as peanuts, mung beans, red beans, fruits and vegetables, tea, etc. Hereafter, a specific implementation aspect of the heat treatment device 10 will be further described with reference to the accompanying drawings, but the particular architecture of the heat treatment device of the present invention is not limited to the examples listed below.

Taking the coffee beans as an example, the roasting process of the coffee beans may release water vapor, and the water vapor left in the cavity 100 may lead to the degradation of the quality of the coffee beans. Thus, in order to solve the aforementioned problem, the heat treatment device 10 of this embodiment further includes, for example, an accommodating space 400 and a hot air device 500. The accommodating space 400 is arranged beside the cavity 100. Specifically, the accommodating space 400 is connected to the first chamber 110, for example, but is not limited thereto. The hot air device 500 is arranged in the accommodating space 400. Furthermore, the accommodating space 400 can also accommodate other components such as a power supply and electric wires, for example, and the motor 310 may also be arranged in the accommodating space 400, for example. The hot air device 500 is suitable for generating hot air H into the second chamber 120. Specifically, the baffle plate 121 arranged on one side of the second chamber 120 further has multiple openings 1212, the other side of the second chamber 120 has an air outlet 122, and the hot air H will enter the second chamber 120 through the openings 1212 and then is discharged from the air outlet 122. Under the condition of smooth air convection, the hot air H can continuously enter the second chamber 120, and the water vapor, smoke and the like generated in the heating process can be collected by the hot air H and discharged together with the hot air H through the air outlet 122, so that the coffee beans in the second chamber 120 can be kept dry, thereby maintaining good quality.

Furthermore, the heat treatment device 10 of this embodiment further includes an air exhausting device 600, for example. The air exhausting device 600 is connected to the air outlet 122 and is suitable for accelerating the discharge of the hot air H. Moreover, the silver skin of the coffee beans may fall off during the roasting process, and the silver skin may also affect the quality of the roasted coffee beans. Because the silver skin is light in weight, the silver skin may be discharged from the air outlet 122 under the effect of a suction force in the case the air exhausting device 600 is provided.

The heat treatment device 10 of the aforementioned embodiment is adjusted according to the material 20 to be heated (the coffee beans). In another embodiment, only one of the hot air device 500 and the air exhausting device 600 may be provided, or neither the hot air device 500 and the air exhausting device 600 is provided, and the present invention is not limited thereto.

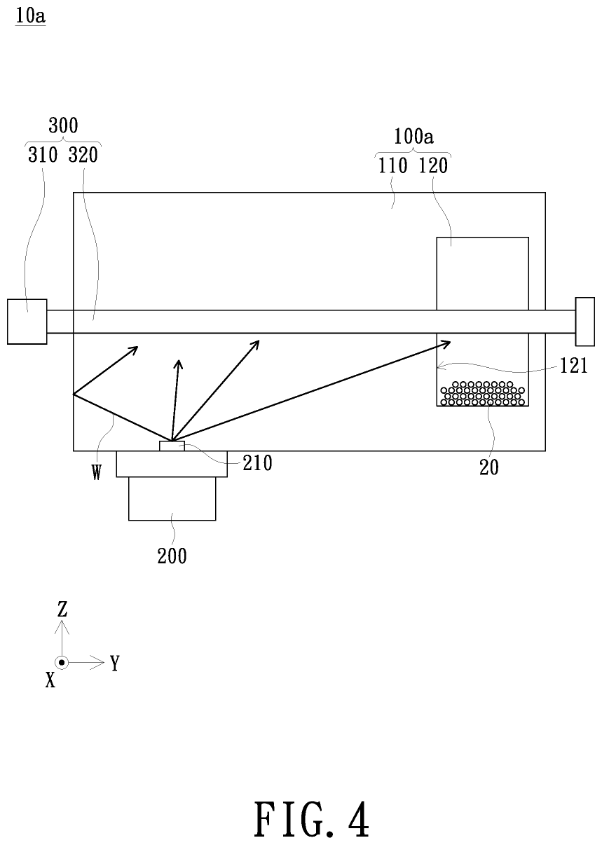

FIG. 4 is a schematic cross-sectional view of a heat treatment device according to another embodiment of the present invention. Please refer to FIG. 4. The heat treatment device 10a of this embodiment has a structure and advantages that are similar to those of the aforementioned heat treatment device 10. The only difference is that in the heat treatment device 10a of this embodiment, the cavity 100a includes the first chamber 110 and the second chamber 120, for example, and the second chamber 120 is arranged in the first chamber 110. Although not shown in FIG. 4, the aforementioned accommodating space 400, the hot air device 500 and the air exhausting device 600 are also suitable for the heat treatment device 10a of this embodiment.

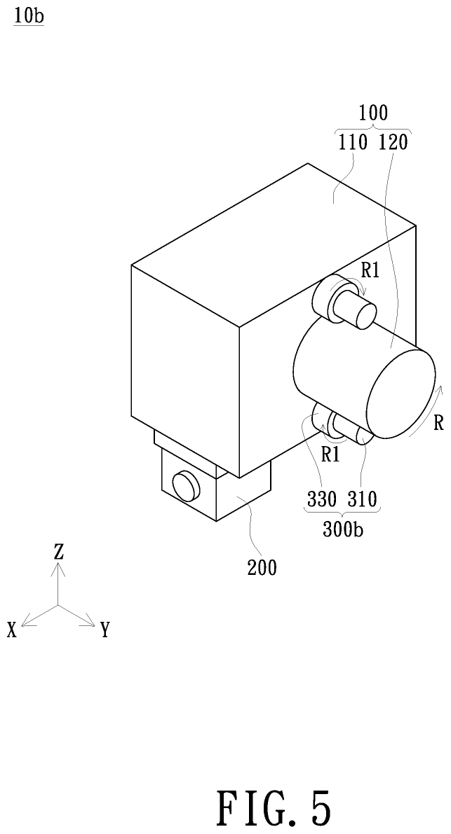

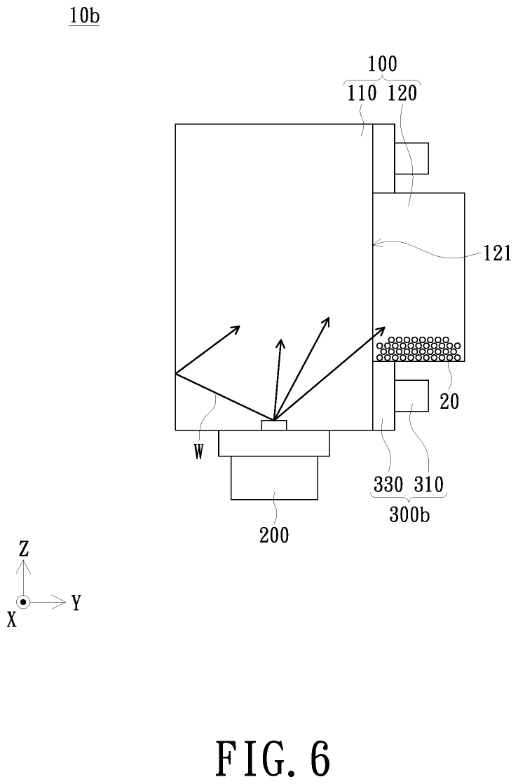

FIG. 5 is a schematic perspective view of a heat treatment device according to another embodiment of the present invention. FIG. 6 is a schematic cross-sectional view of a heat treatment device according to another embodiment of the present invention. Please refer to FIGS. 5 and 6. The heat treatment device 10b of this embodiment has a structure and advantages that are similar to those of the aforementioned heat treatment device 10, and only the main differences in structure will be described below. In the heat treatment device 10b of this embodiment, the stirring element 300b is arranged beside the second chamber 120 and includes a motor 310 and a gear 330, for example. The motor 310 is connected to the gear 330. The gear 330 abuts against the second chamber 120, and is suitable for driving the second chamber 120 to rotate along the rotation direction R. A rotation direction R1 of the gear 330 is opposite to the rotation direction R of the second chamber 120. The gear 330 can be replaced by a roller or other circular elements that can drive the second chamber 120 to rotate, and the present invention has no particular limitation on this. In FIGS. 5 and 6, the number of the gears 330 is two as an example, but the present invention does not particularly limit the number of the gears 330, that is, one or more than two gears 330 may be provided. The number of the motors 310 corresponds to the number of the gears 330. Moreover, although not shown in FIGS. 5 and 6, the aforementioned accommodating space 400, the hot air device 500 and the air exhausting device 600 are also suitable for the heat treatment device 10b of this embodiment.

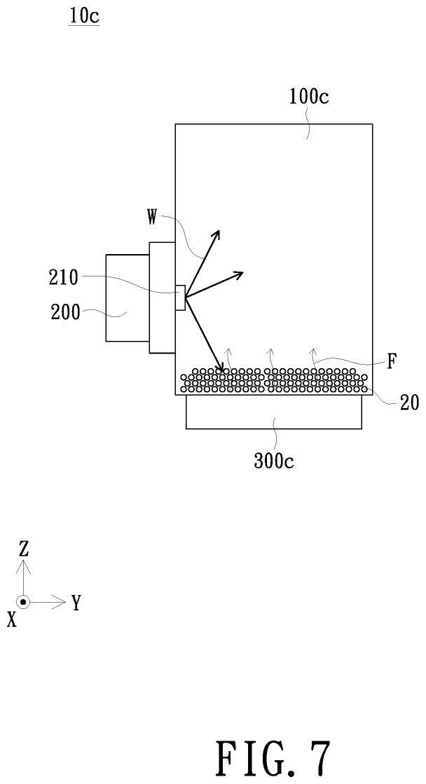

FIG. 7 is a schematic cross-sectional view of a heat treatment device according to another embodiment of the present invention. Please refer to FIG. 7. The heat treatment device 10c of this embodiment has a structure and advantages that are similar to those of the aforementioned heat treatment device 10, and only the main differences in structure will be described below. In the heat treatment device 10c of this embodiment, the material 20 is arranged in the cavity 100c, and the space in the cavity 100c is not partitioned. The stirring element 300c is arranged beside the cavity 100c. The stirring element 300c includes a fan, which is suitable for providing aerodynamic force F into the cavity 100c to stir the material 20. In this embodiment, the fan 300c (the stirring element 300c) is arranged under the cavity 100c, and the fan 300c provides the upward aerodynamic force F into the cavity 100c, and thus the material 20 (such as the aforementioned coffee beans) will be blown upward under the effect of the aerodynamic force F. In FIG. 7, the direction of gravity (not shown) is parallel to the direction of Z-axis, for example. When the gravity applied on the material 20 is greater than the aerodynamic force F, the material 20 will fall down. Thus, the effect of stirring is achieved by up and down, reciprocating movements of the material 20, so that the microwave W can uniformly heat the material 20.

In the heat treatment device of the embodiments of the present invention, the microwave generator provides the microwave into the cavity to perform heat treatment on the material in the cavity, and then the material is stirred by the stirring element, so that the material can be constantly turned over in the cavity. Thus, the microwave can be evenly transmitted to every part of the material, thereby achieving the effect of high efficiency and stable, uniform heating.

What is claimed is:

1. A heat treatment device suitable for performing heat treatment on a material, the heat treatment device comprising:
a cavity, wherein the material is arranged in the cavity;
a microwave generator, arranged beside the cavity and suitable for providing a microwave into the cavity; and
a stirring element, arranged beside the cavity and suitable for stirring the material.

2. The heat treatment device according to claim 1, wherein the cavity comprises a first chamber and a second chamber, the material is arranged in the second chamber, and the microwave is reflected within the first chamber and the second chamber.

3. The heat treatment device according to claim 2, wherein the stirring element comprises a motor and a rotating shaft, the motor is connected to the rotating shaft, the second chamber is sleeve-connected and fixed to the rotating shaft, and the rotating shaft is suitable for driving the second chamber to rotate.

4. The heat treatment device according to claim 2, wherein the second chamber is cylindrical, the stirring element comprises a motor and a gear, the motor is connected to the gear, and the gear abuts against the second chamber and is suitable for driving the second chamber to rotate.

5. The heat treatment device according to claim 2, wherein the second chamber is arranged in the first chamber.

6. The heat treatment device according to claim 2, wherein the second chamber is arranged beside the first chamber and connected to the first chamber.

7. The heat treatment device according to claim 2, wherein one side of the second chamber has a baffle plate, and the microwave enters the second chamber through the baffle plate.

8. The heat treatment device according to claim 2, further comprising a hot air device, wherein an air outlet is arranged on one side of the second chamber, and the hot air device is suitable for generating hot air into the second chamber and then the hot air is discharged from the air outlet.

9. The heat treatment device according to claim 2, further comprising an air exhausting device connected to an air outlet arranged on one side of the second chamber.

10. The heat treatment device according to claim 1, wherein the stirring element comprises a fan suitable for pushing air into the cavity to aerodynamically stir the material inside the cavity.
